(19) United States
(12) Patent Application Publication
(10) Pub. No.: US 2018/0357470 A1
(43) Pub. Date: Dec. 13, 2018

(54) BIOMETRIC EAR IDENTIFICATION

(71) Applicant: STMicroelectronics, Inc., Coppell, TX (US)

(72) Inventors: Xiaoyong Yang, San Jose, CA (US); Rui Xiao, San Jose, CA (US)

(21) Appl. No.: 15/617,866

(22) Filed: Jun. 8, 2017

(51) Int. Cl. G06K 9/00; H04L 29/06; H04W 12/06; G06F 3/16; G06T 7/521

(52) U.S. Cl. CPC G06K 9/00255; H04L 63/0861; G06T 7/521; G06K 9/00899; G06F 3/165; H04W 12/06

(57) ABSTRACT

The present disclosure is directed to a system and method of scanning an ear of a user to identify the user. The system includes a ranging sensor that detects the distance between the user and the ear detection system at one or more points and transmits that as ranging data. The ranging data is used to generate a depth model of the user's ear, from which an ear profile can be generated and compared to stored ear profiles to identify and authenticate the user. Once authenticated, the system can then enter a different operating mode based on the authentication.

### BACKGROUND

### Technical Field

The present disclosure is directed to a system and method for controlling a system based on identifying a user, and, in particular, to a system that identifies a user by scanning an ear of the user.

### Description of the Related Art

In current devices with user authentication, various processes and devices are used to unlock the devices or specific content on the devices. One example of user authentication is the use of a lock screen with a password or pin. The user is prompted to enter the user's password or pin to access content on the device, or to access a specific user profile of the device which has access to saved messages, contacts, images, videos, etc. for the user of that user profile.

Other technologies for user authentication include fingerprint sensors, facial recognition sensors, and iris scanning. These biometric technologies capture fingerprints or facial features, respectively, with scanners in the mobile device. A fingerprint biometric scanner receives a finger placed on a scanner at the surface of the device. The scanner scans the finger to produce a digitization of the fingerprint for the finger. The digitization of the fingerprint is compared to a stored copy, and, if a match is found, the user is authenticated for access to the device or specific device content. For facial recognition sensors, a camera in the device is used to take a picture of the face of a user of the device. The photo of the user is compared to a stored image of the user, and, if a match is found, the user is authenticated for access to the device or specific device content. Iris scanning uses a camera to take a picture of an iris in an eye, and compares the visual features of the iris to a stored image of the iris, with a match providing user authentication.

There are significant limitations associated with the above user authentication techniques. For example, a fingerprint can rub off or callous over after hard or repetitive labor with the hands. Furthermore, a fingerprint can be fairly easily replicated and spoofed to circumvent fingerprint authentication. Facial recognition is limited by the amount of variation is present in a person's facial features, as hair, glasses, and headwear can prevent accurate matches from being made. In addition, masks can spoof the facial recognition software. Similarly, an iris based biometric identification can be spoofed with patterned contact lenses.

### BRIEF SUMMARY

The present disclosure is directed to a system for authenticating a user based on a scan of the user's ear. A ranging sensor scans a user's ear and generates ranging data. The ranging data is associated with position information such that a processor can build a depth model (relief map) of the ear with the ranging data and the position information. The depth model of the ear can then be compared to a stored ear profile to identify the user by the user's ear profile.

In some embodiments, the identification of the user causes a user's device to be unlocked by the processor, or causes the processor to initiate personalized audio content playback to the user. In some embodiments, the system maintains a user's device in an unlocked state, or continues audio playback for a period of time after an identification of the user by the user's ear profile. In some embodiments, the ranging sensor detects the presence of an ear instead of a specific profile.

### BRIEF DESCRIPTION OF THE SEVERAL VIEWS OF THE DRAWINGS

FIG. 1 is a schematic of an ear detection system.

FIG. 2 is a perspective view of a ranging sensor having multi-zone detection and value outputs.

FIGS. 3A and 3B depict two embodiments of ear profiling techniques.

FIGS. 4A and 4B each depict an embodiment of a system incorporating an ear detection system.

FIG. 5 depicts a process of scanning zones of a SPAD array of a ranging sensor.

### DETAILED DESCRIPTION

In the following description, certain specific details are set forth in order to provide a thorough understanding of various embodiments of the disclosure. However, one skilled in the art will understand that the disclosure may be practiced without these specific details. In other instances, well-known structures associated with electronic components and fabrication techniques have not been described in detail to avoid unnecessarily obscuring the descriptions of the embodiments of the present disclosure.

Unless the context requires otherwise, throughout the specification and claims that follow, the word “comprise” and variations thereof, such as “comprises” and “comprising,” are to be construed in an open, inclusive sense; that is, as “including, but not limited to.”

Reference throughout this specification to “one embodiment” or “an embodiment” means that a particular feature, structure or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

As used in this specification and the appended claims, the singular forms “a,” “an,” and “the” include plural referents unless the content clearly dictates otherwise. It should also be noted that the term “or” is generally employed in its sense including “and/or” unless the content clearly dictates otherwise.

As used in the specification and appended claims, the use of “correspond,” “corresponds,” and “corresponding” is intended to describe a ratio of or a similarity between referenced objects. The use of “correspond” or one of its forms should not be construed to mean the exact shape or size.

The present disclosure is directed to methods, systems, and devices for identifying a user based on scanning the user's ear. The devices include a ranging sensor and a processor for analyzing data from the ranging sensor. The ranging sensor detects distances from the ranging sensor to an ear, and the processor builds a model of the ear with the distance information. The device then correlates the ear model with a saved ear profile to determine if there is a match. Ear identification has been demonstrated with a 99.6% level of accuracy. This level of accuracy increases when ear identification is combined with other security methods, such as face, eye, palm, fingerprint, voice, pin, or password.

Each ear is unique, like a fingerprint. Each ear has a plurality of contours, depths, and relationships between these contours and depths that are unique to that individual ear. Security features, such as fingerprint sensors and passwords are used to prevent unauthorized access to various electronic devices or systems, such as cell phones, tablets, and other mobile devices. Security features are used in people's homes or work environments where access is limited to specific individuals. Time of flight sensors, incorporated in these existing security systems can provide cost effective, low power detection of unique features of individuals, such as by detecting distances from the time of flight sensor to a user's ear.

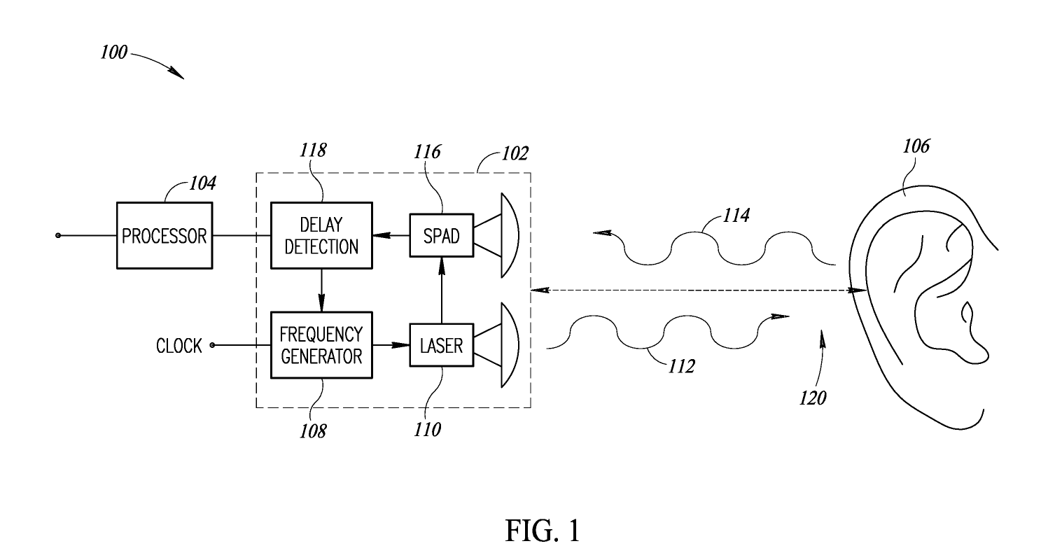

FIG. 1 depicts one embodiment of an ear detection system 100. The ear detection system 100 uses a ranging sensor 102 and a processor 104 to detect an ear 106 of a user. Ear detection can be completed by producing a depth model of the ear 106 using the ranging sensor 102 and the processor 104, and comparing the depth model of the ear 106 to a stored ear profile. The system 100 can be used to create the stored ear profile as well. Alternatively, the depth model of the ear 106 can be analyzed for specific features, and those features compared to the stored ear profile. In other embodiments, other analysis methods of the ear can be used.

The ear analysis is based on ranging data from the ranging sensor 102. To produce the ranging data, the ranging sensor 102 uses time-of-flight ranging, in which a signal is broadcast from the ranging sensor 102, and the time it takes for a return signal to be received at the ranging sensor 102 is used to calculate distance between the ranging sensor 102 and an obstruction, such as the ear 106. The ranging sensor is held at a distance from the user's ear. The ranging sensor may be incorporated within a cell-phone or other mobile device that has security features to prevent unauthorized access to the device.

To implement the time-of-flight system, ranging sensor 102 receives a timing signal CLOCK used to initiate a transmission of a ranging signal. The timing signal CLOCK triggers a frequency generator 108 to begin producing a drive signal. The drive signal produced by the frequency generator 108 drives a laser 110 to cause the laser 110 to generate an optical signal.

When driven by the frequency generator 108, the laser 110 produces a broadcast ranging signal 112. The broadcast ranging signal 112 can be an optical signal that is invisible. Alternatively, the broadcast ranging signal 112 can be an optical signal that is visible. The optical signal can be output as a pulse, with a time delay between each pulse to provide for the processing of the distance information gathered from the pulse. The broadcast ranging signal 112 is projected out from the laser 110, and propagates away from the laser 110 until hitting an obstruction, such as the ear 106 of the user. When the broadcast ranging signal 112 hits the obstruction, it can be reflected back to the ranging sensor 102 as a return ranging signal 114. The return ranging signal 114 is one of any number of reflections of the broadcast ranging signal 112, and specifically is the one that is in the opposite direction as the broadcast ranging signal 112 towards a sensor.

The return ranging signal 114 is received at an array of single photon avalanche diodes (SPAD) 116. The SPAD 116 detects photons in the wavelength of the emissions of the laser 110, such as the return ranging signal 114. When a photon is received at the SPAD 116, the SPAD 116 signals receipt of the returned signal. Although not shown, the time-of-flight sensor includes a reference SPAD array and a return SPAD array. The reference SPAD array receives an internally reflected signal from the broadcast ranging signal. The return SPAD array receives the reflected signal that bounces off or is otherwise reflected from an object in the field of view of the time-of-flight sensor. A comparison of the time of detection of the internally reflected signal at the reference SPAD array with a time of detection of the externally reflected signal at the return SPAD array generates the distance measurement.

The reference SPAD detects the broadcast ranging signal 112 and the return SPAD detects the return ranging signal 114. The reference SPAD photon detection causes a reference trigger signal and the return SPAD photon detection causes a return triggers signal. The trigger signals are sent to delay detection circuitry 118. The delay detection circuitry 118 estimates distances based on a time difference between the reference trigger signal and the return trigger signal. As approximate speed of the broadcast ranging signal 112 and the return ranging signal 114 are known, distance can be calculated using the propagation time of the ranging signals 112, 114. The propagation time is calculated by subtracting or comparing time of receipt of the reference trigger signal from the time of receipt of the return trigger signal.

The delay detection circuitry 118 utilizes suitable circuitry, such as time-to-digital converters or time-to-analog converters that generate an output indicative of a time difference that may then be used to determine the time of flight of the ranging signals 112, 114, and thereby the ranging distance 120 to the ear 106. In some embodiments, the delay detection circuitry 118 includes a digital counter, which counts a number of photons received at each SPAD 116. Then, by analysis of the photon counts received at each SPAD 116, the delay detection circuitry 118 determines a distance to the object.

The processor outputs information to the device in which the ranging sensor ear detection circuit is incorporated. The output information may be an interrupt signal or an unlock signal that deactivates a security feature implemented on the device.

In other embodiments, the ranging sensor 102 includes additional device elements to produce the ranging data. For example, the broadcast ranging signal 112 can be triggered by a digital signal processing (DSP) and system control unit having an microcontroller unit, read-only memory, and a register bank that process parallel DSP channels. The DSP and system control unit generates a laser trigger that along with a plurality of clock signals activates a laser clock controller. The laser clock controller then determines based on the laser trigger signal and the plurality of clock signals, when to engage the laser driver, which in turn powers the laser.

The emitted laser can be reflected into a reference SPAD array at the laser and reflected into a return SPAD array from reflecting off of an obstruction. Those reflections generate signals at the SPAD arrays that are transmitted to a signal router, which then supplies the signals to an array of time to digital converters that are activated according to a plurality of clock signals from a phase locked loop (PLL) clock circuit. The PLL clock circuit also outputs a clock signal to the DSP and system control unit, along with the digital signals from the parallel time to digital converters. These signals are processed by the parallel DSP channels to determine an ambient time of flight. Other ancillary circuits can also be provided, such as bandgap controllers and power regulators to supplement the circuits in the ranging sensor 102.

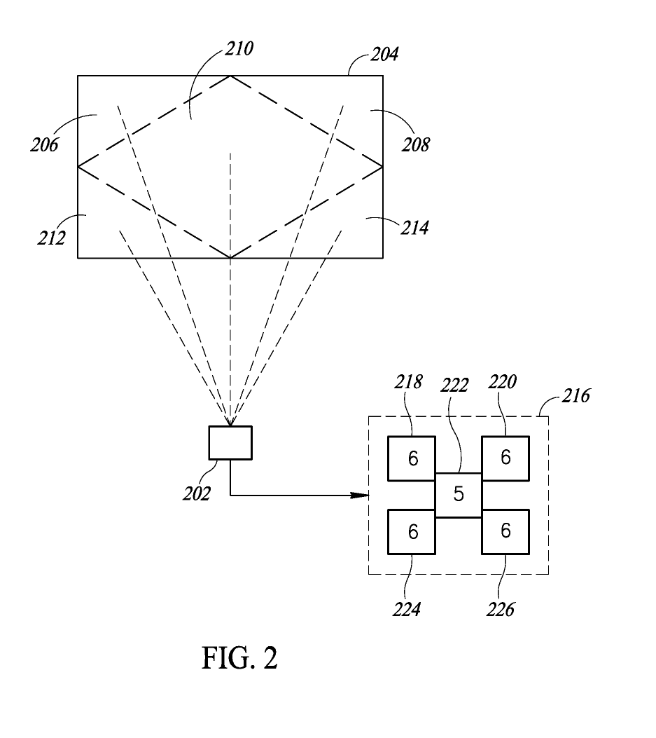

FIG. 2 is a perspective view of one embodiment of a ranging sensor having multi-zone detection and value outputs. A ranging sensor 202 can detect multiple distances in a single distance detection step, i.e. a single optical pulse. The ranging sensor may be a time of flight sensor that can output multiple distance measurements, which is in contrast to traditional time of flight sensors that output a single distance. This allows the ranging sensor 202 to detect multiple points on a surface or points on multiple surfaces simultaneously. The ranging sensor 202 has a field of view that is directed towards an obstruction 204, with a planar surface (with a normal vector that is parallel to a normal vector from the lens of the ranging sensor 202). The different sections of the obstruction 204 are at different distances from the ranging sensor 202 because of the increased distance associated with being off of center from the ranging sensor 202.

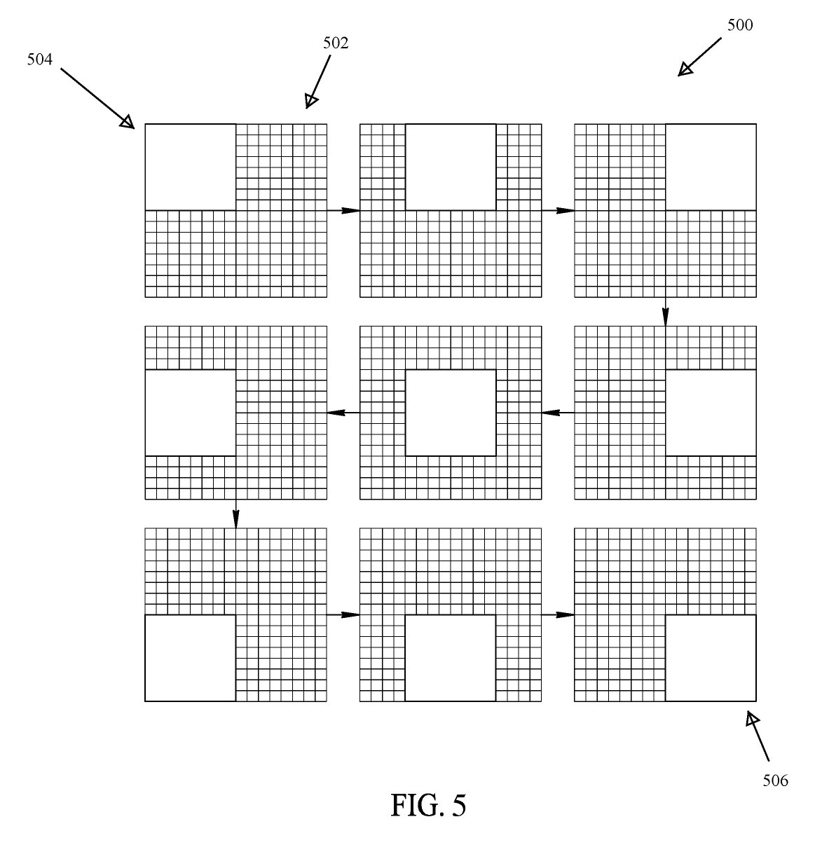

In FIG. 2, the ranging sensor 202 has a SPAD array with a 5-zone detection capability, which can output a different distance for each zone giving the ranging sensor more robust detection capabilities. Other numbers of zones for multi-zone detection capability are possible (e.g., 9-zone, 12-zone, and 16-zone). The zones can be any shape based on the specific design of the ranging sensor 202, including arrangement of the photon detection cells in an array. As will be discussed in greater detail with respect to FIG. 5, the zones each correspond to a plurality of cells in the array of ranging sensors. A first detection zone 206 in the field of view corresponds to a top left corner of the obstruction 204 and is associated with a first portion 218 of the SPAD array 216. A second detection zone 208 corresponds to a top right corner of the obstruction 204 and is associated with a second portion 220 of the SPAD array 216. A third detection zone 210 corresponds to a center of the obstruction 204 and is associated with a third portion 222 of the SPAD array 216. A fourth detection zone 212 corresponds to a bottom left corner of the obstruction 204 and is associated with a fourth portion 224 of the SPAD array 216. A fifth detection zone 214 corresponds to a bottom right corner of the obstruction 204 and is associated with a fifth portion 226 of the SPAD array 216.

The ranging sensor 202 detects a distance to each respective zone of the obstruction 204. The zones are fixed with respect to the ranging sensor 202. The obstruction 204 is shown having a flat surface with a normal vector that passes through the center of the obstruction 204 and points at the ranging sensor 202. Because of this positioning of the obstruction 204, each one of the corners of the obstruction 204 is an equal distance from the ranging sensor 202. For example, each of the first, second, fourth, and fifth portions 218, 220, 224, 226 register a distance of 6. Because the surface of the obstruction 204 is flat, and orthogonal to a line to the ranging sensor 202, the third detection zone 210 is closer to the ranging sensor 202 and the third portion 222 registers a distance of 5. In a single distance measurement, five distance values are output by the ranging sensor 202.

The same distance values across the first, second, fourth, and fifth portions 218, 220, 224, 226 reflect how the corners of the obstruction 204 are an equal distance from the ranging sensor 202. Additionally, the difference between the distance of third portion 222 and the first, second, fourth, and fifth portions 218, 220, 224, 226 reflects how center of the obstruction 204 is closer to the ranging sensor 202 than the corners. This difference can be because of the obstruction not having a planar surface or from the angles to the corners increasing the distance between the ranging sensor 202 and the respective detection zone of the obstruction 204.

The values for the zone distances 218, 220, 222, 224, 226 can be a true distance (e.g., 6 represents 6 units of measurement, such as 6 centimeters). Alternatively, the value of 6 represents a normalized distance (e.g., a 6 out of 10, with 10 representing the maximum detection distance of the ranging sensor 202 and 0 representing the minimum detection distance of the ranging sensor 202).

The value of 6 can also represent a different unit of measure, such as time. The other zones are any of the different data types discussed. These values can be output from the ranging device on separate output paths, which are received by the processor. Alternatively, there may be a single output terminal where the different outputs can be interpreted by the processor.

If the obstruction is an ear, the multi-zone detection in a single sensor allows for compact multi-depth detection for each distance measurement. For an ear, which has many contours and depths, each distance measurement will provide a plurality of data points about features of the ear. Over a series of distance measurements, the plurality of data points can be blended or stitched to represent a user's ear. The representation is compared to stored ear data to determine if a match exists. If a match is identified, the user can be authenticated to the system, which can authorize access to the electronic device, or to specific data, whether on the device or in the cloud. If no match is identified, then the electronic device can provide a warning message, haptic feedback, or some other type of feedback.

With multi-zone detection capability, it is further possible to implement various data blending schemes to increase the number of zones to be scanned, among other benefits. For example, a scan can be taken by the ear detection system 100 having the ranging sensor 202 with multi-zone detection capability. The ear detection system 100 is then moved such that the first detection line 206 overlaps where the second detection line 208 was and the fourth detection line 212 overlaps where the fifth detection line 214 was. The ear detection system 100 determines that the zones partially overlap the previous scan by comparing the overlapping distance data. This process can continue as the ear detection system 100 continues to move during scanning, stitching the data together.

Different embodiments have differing levels of fidelity for the ranging sensor 202 in detection of the obstruction 204. In some embodiments, the ranging sensor 202 has only single zone detection capability, resulting in the processor 104 being able to detect an obstruction with high confidence. In some embodiments, the ranging sensor 202 has a small multi-zone detection capability, such as 9 zones, resulting in the processor 104 being able to differentiate an ear from another object with high confidence. In some embodiments, the ranging sensor 202 has a moderate multi-zone detection capability, such as 144 zones, resulting in the processor 104 being able to differentiate a group of ear types from another group of ear types with high confidence. In some embodiments, the ranging sensor 202 has a large multi-zone detection capability, such as 1024 zones, resulting in the processor 104 being able to identify an ear from other ears. The various numbers of zones may result in other detection capabilities at the processor 104 and at different levels of confidence.

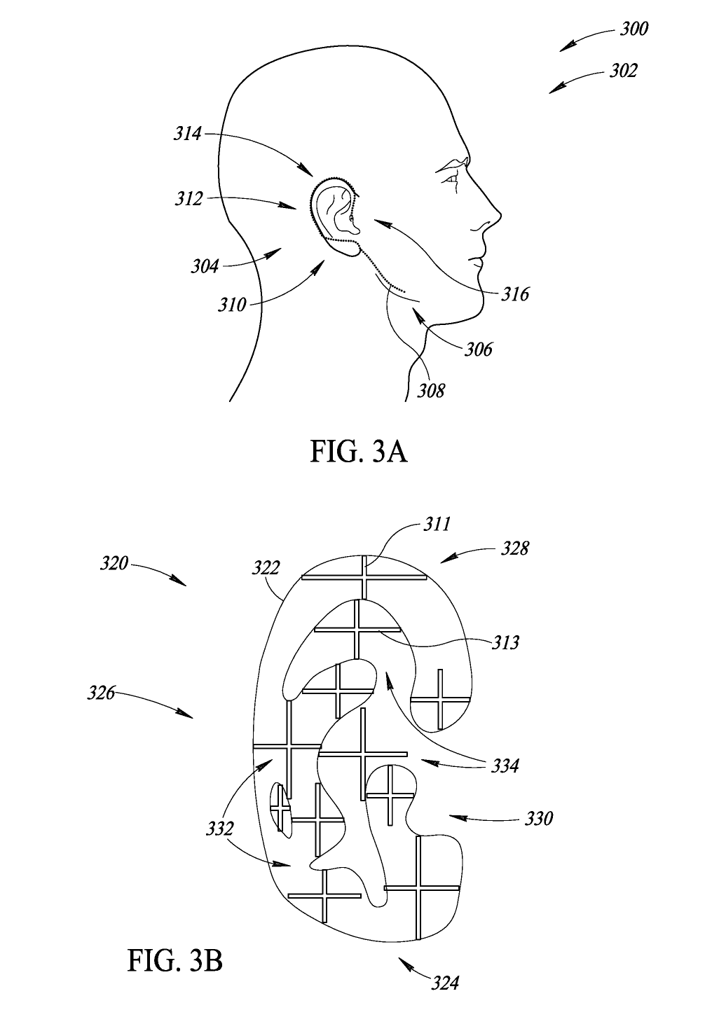

FIGS. 3A and 3B depict two embodiments of ear profiling techniques using the ear detection systems of the present disclosure. FIG. 3A depicts using an edge of an ear and a line of a jawbone to uniquely identify a user. In this embodiment, a user 300 is shown in a profile view, with the main facial structure illustrated. The profile view focuses on a head 302 of the user, the head 302 including an ear 304 and a jawbone 306.

Traced over the head 302 in a dashed line is an ear profile 308. The ear profile 308 follows major structural features of the jawbone 306 and the ear 304. Different users can have detectable differences in their respective ear profiles 308. By using a ranging sensor to detect the ear profile 308 for the user 300, and then matching the ear profile 308 against a stored ear profile, a user can be identified.

To generate the ear profile 308, the ranging sensor is used to generate a depth model of a side of the head 302. This depth model is then analyzed to determine where the depth model suggests the jawbone 306 and the ear 304 are and what their contours look like, based on the distance information. The ear profile 308 identifies from the depth model where the jawbone 306 turns up toward a crown or top of the head 302. The ear profile 308 begins just before about where the jawbone 306 turns up, and traces along the jawbone towards the ear 304.

At the ear 304, the ear profile 308 circles around the ear 304. At the location in which the jawbone 306 meets the ear 304, the ear profile 308 traces across an inferior (lower) ear portion 310, including an ear lobe. At this portion of the ear 304, the ear profile 308 traces across an interior portion of the ear 304 instead of around the outside edge of the ear 304. This section of the ear profile 308 can be drawn parallel to a horizon or ground surface, or can be set with respect to some other reference.

The ear profile 308 then traces along the outside of the ear 304, including an ear helix. Thus, after tracing across the inferior ear portion 310, the ear profile traces along an outside edge of a posterior (rear) ear portion 312 and continues up and across a superior (upper) ear portion 314. At an anterior (forward) end of the superior ear portion 314, the ear profile 308 turns down and follows an inside edge of an anterior ear portion 316, including an ear tragus. The ear profile 308 terminates at about where the inside edge of the anterior ear portion 316 turns forward, moving as you trace down from the superior ear portion 314.

The depth information can be used in the above way to generate the ear profile 308 of the user 300, which can then be compared to a stored ear profile to determine if they match. Other types of ear profiles can also be used to identify a user.

The system scans the ear and face of the user to establish the stored ear profile information. The system captures a plurality of distances that represent a relationship between the various features of the user's side of their face, including the jaw and ear. In FIG. 3A, the ear profile 308 is a representation of a plurality of contours associated with the user. This ear profile 308 may be a collection of depths associated with these points on the user such that the system can subsequently identify when the same series of depths is scanned again.

FIG. 3B depicts using a contour map of an ear to uniquely identify a user. In this embodiment, an ear 320 is shown in a profile view, with a contour line 322 corresponding to parts of the ear 320 at a specific distance from a ranging sensor. Instead of tracing a line along major facial features, as discussed above with respect to FIG. 3A, this embodiment is directed to generating crosshairs that define the major peaks and valleys of the ear 320, i.e. various depth profiles that represent features of the ear. The depth information gathered is processed to output ear representation. As a user cannot hold the ranging sensor perfectly still, each scan or distance measurement will be a little different, however over a scan period, the system can average or otherwise weight the different detected distances to create the ear profile.

Like FIG. 3A, the ear 320 is shown with an inferior ear portion 324, a posterior ear portion 326, a superior ear portion 328, and an anterior ear portion 330. These ear portions each have peaks and valleys with respect to the contour line 322. Crosshairs are generated to quantify each of the peaks and valleys. In certain peaks and valleys, crosshairs are generated that stretch out between different sections of the contour line 322 to fill a space. Ear profile peaks 332 are quantified by identifying a center of the crosshairs and a height and a width of the crosshairs. Similarly, ear profile valleys 334 are quantified by identifying a center of the crosshairs and a height and a width of the crosshairs. Some embodiments of the ear profile include the ear profile peaks 332 and the ear profile valleys 334 each having respective crosshairs with ends touching the contour line 322. Some embodiments of the ear profile include one or more of the ear profile peaks 332 or the ear profile valleys 334 having crosshairs with one or more ends not touching the contour line 322.

The major peaks and valleys identified by the crosshairs represent a plurality of post-processed data points. For example, a first crosshair 311 identifies a region of the user's ear that is closer to the ranging sensor. This corresponds to a top portion of a user's ear that is the ear helix. A second crosshair 313 represents a depression of the user's ear, such that an area of the second crosshair is all further from the ranging sensor than the area associated with the first crosshair 311.

With the crosshairs quantified for an ear profile, the ear profile can be compared to a stored ear profile to determine if the ear matches, and a positive identification of a user can be made. The two above methods of generating an ear profile from a depth model of an ear are exemplary, and other similar methods are within the scope of this disclosure. In some embodiments, other methods may be used for using a depth model to identify a user from the user's ear.

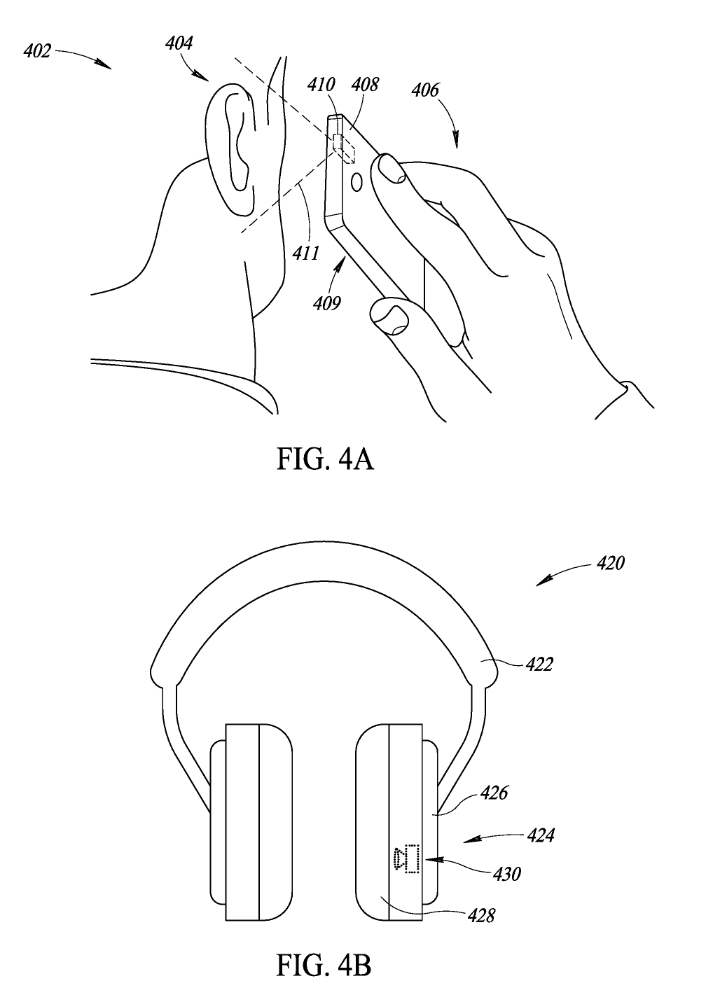

FIGS. 4A and 4B each depict an embodiment of a system incorporating an ear detection system. Each of these systems includes a plurality of additional devices for more robust functionality. For example, in FIG. 4A a user 402, as seen from the rear, is using a mobile phone or hand-held electronic device 408. The user 402 is holding their mobile device to their ear 404 with their hand 406.

The mobile device 408 includes a display on a first side 409 of the mobile device that is facing the user's ear. The display may be a touch screen or other interface that receives inputs from the user and displays information to be viewed by and interacted with by the user. In addition, the mobile device 408 can have a speaker for playing audio content. The mobile device may perform any number of functions, such as wireless calling, sending and receiving emails, or other functions as selected by the user.

The mobile device 408 includes an ear detection system 410 with a ranging sensor having a field of view 411 extending from the first side 409 of the mobile device 408 towards the ear 404. As the user 402 brings the mobile device 408 towards the ear 404, the ear detection system 410 scans the ear 404 of the user 402 to generate an ear profile according to any of the embodiments mentioned in this disclosure. If the ear profile matches a stored ear profile, then the mobile device 408 transitions from a first mode to a second mode.

In some embodiments, the first mode is a locked state and a second mode is an unlocked state. The locked mode prevents access to certain features of the mobile device 408, such as calling, camera functions, personal information storage, or any other feature. In some embodiments, the first mode is under a general user account and the second mode is under a specific user account. For example, general calling is available in the first mode, and calling using a personal contact book is available in the second mode.

In one embodiment, the user can move the mobile device 408 towards their ear if they want to make call. The ear detection system 410 can detect the ear quickly and within the movement of bringing the mobile device 408 to the user's ear 404, detect and activate the mobile device 408. Once the ear 404 is used to confirm the user 402 as an authorized user, the mobile device 408 may output an audible inquiry over the speaker to the user 402, such as “who do you want to call?” The user 402 may identify vocally a contact they wish to call, such that in a single movement the mobile device 408 is unlocked by ear detection and a call is made by voice selection.

FIG. 4B depicts headphones 420 that can incorporate an ear detection system according to the present disclosure. The headphones 420 are shown as over-the-ear style headphones, but can be any type of headphones in other embodiments. The headphones 420 include a head band 422 that rests on or over the head of a user and a pair of ear pieces, including an ear piece 424. The ear piece 424 includes a mount 426 and a cushion 428. The mount 426 provides structure to support the cushion 428 and an audio speaker, and to connect to the head band 422. The cushion 428 provides a gentle interface between the user and the headphones 420.

Inside the mount 426 is an ear detection system 430. As the user positions the headphones 420 over an ear of the user, the ear detection system 430 scans the ear of the user to generate a depth model of the ear of the user. The depth model is passed to a processor (not shown) to generate an ear profile according to any of the embodiments mentioned in this disclosure. If the ear profile matches a stored ear profile, then the processor can signal for a transition from a first mode to a second mode of the headphones 420, the processor, or any other device. The transition between modes can be based on the state of a status signal.

In some embodiments, the first mode is a locked state and a second mode is an unlocked state. The locked mode prevents access to certain features, such as personal media library access, personal audio balancer settings, or any other feature. In some embodiments, the first mode is under a general user account and the second mode is under a specific user account. For example, general music playback over the speaker is available in the first mode, and a personal playlist of music is automatically played over the speaker in the second mode.

In some embodiments, the transition from the first mode to the second mode happens at the time of detection or identification of the user's ear, and the transition from the second mode to the first mode occurs at the time of loss of detection or identification of the user's ear. In other embodiments, there is a time delay between one or both of the triggering events and the mode transition. For example, the device can be immediately unlocked upon identification of the user, but there be a two minute delay from loss of detection of the user's ear to locking the device. In another example, playback of audio content might not begin until two second after the user's ear is detected, but immediately paused after loss of detection of the user's ear.

In other embodiments, the transition between the first mode and the second mode is based on detection of an obstruction. For example, if the ear detection system 430 in the headphones 420 detects anything near the cushion 428, the device can transition from the first mode in which audio is not being played to the second mode in which audio is being played. Then when the ear detection system 430 stops detecting anything near the cushion 428, the device can transition from the second mode in which audio is being played to the first mode in which audio is not being played. Other embodiments can also be used with ear detection or ear identification processes. In some embodiments the ear detection system works in conjunction with other biometric security systems to increase accuracy of user identification.

FIG. 5 depicts a process of scanning zones of a SPAD array of a ranging sensor. Shown in FIG. 5 is one embodiment of a multi-zone scan 500 of SPAD array 502. The SPAD array 502 includes an array of 256 individual SPADs in a 16×16 configuration that provides an overall field of view of about 27 degrees. The depicted embodiment demonstrates a 9-zone scan, with a 3×3 zone scanning pattern. Each zone includes 64 individual SPADs of the SPAD array 502 in an 8×8 configuration.

A first zone 504 is shown over the SPAD array 502 at a first cycle and a last zone 506 is shown over the SPAD array 502 at a last cycle, here being a ninth cycle. The progression of the zones is shown with arrows indicating that the zones move from a position of the first zone 504 to the right, then down, then to the left, then down, and then to the right to arrive at a position of the last zone 506. The first zone overlaps the zone immediately to the right of it and immediately below it each by 32 individual SPADs of the SPAD array 502 in a 4×8 configuration. The first zone overlaps the zone immediately diagonal to it by 16 individual SPADs of the SPAD array 502 in a 4×4 configuration. Each of the other zones has similar overlaps with adjacent zones.

At each cycle, one of the zones is polled to determine time of receipt of a reflection of a ranging signal. The detection results for each of the 64 individual SPADs of the SPAD array 502 for that respective zone are combined such that an aggregated histogram is generated for each zone, in addition to ranging distance and signal data. The scan at each cycle can take approximately 16 ms, with all 9 cycles to scan the 9 zones taking a total of 144 ms. The scanning can be fully managed by a driver running on a host processor. Wrap around calculations can also be handled by the processor.

In other embodiments, a 16-zone scan with a 4×4 zone scanning pattern can be implemented on the SPAD array 502. Each zone includes 36 individual SPADs of the SPAD array 502 in a 6×6 configuration. Adjacent zones can overlap by 12 individual SPADs of the SPAD array 502 in a 2×6 configuration at the sides and by 4 individual SPADs of the SPAD array 502 in a 2×2 configuration at the diagonal. The scan at each cycle can take approximately 16 ms, with all 16 cycles to scan the 16 zones taking a total of 256 ms.

In yet other embodiments, the frames can be divided into subframes, with different sections of each of the subframes being scanned with the corresponding sections of the other subframes, with the subframes being 4 macropixels ore ROI in some embodiments. Thus the 9-zone scan can be subdivided such that each zone has 4 equally sized subframes, or quadrants. Then each zone has an upper subframe of each of the 9 zones polled for timing data. The remaining subframes are then similarly polled in turn with the corresponding subframes from each zone. This method has been shown to support 60 frames per second (fps) rates with 4 subframes delivered at 15 fps total for a region of interest (ROI).

The sensor may implement a 9zone scan, or some other multi-zone scan in a detection sequence to output the multiple distances. As discussed above, in a simplified discussion of operation of a time of flight ranging sensor, the single optical pulse from the laser results in multiple distance outputs. To get more accurate distance outputs the sensor may scan in a sequence of detection steps, using sequential optical pulses. The processor processes the various outputs from the multi-zone scan to generate the multiple distance outputs.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

We claim:

1. A system, comprising:
a distance detection circuit; and
a processor that in operation:
controls the distance detection circuit to:
transmit an optical signal to an ear; and
detect a plurality of distances from the distance detection circuit to the ear with a received optical signal;
compares the plurality of distances to a stored ear profile; and
outputs a status signal in response to the plurality of distances corresponding to the stored ear profile.

2. The system of claim 1 wherein the distance detection circuit includes:
a first signal receiver that detects the received optical signal; and
a second signal receiver that detects a second received optical signal, the distance detection circuit determines the plurality of distances based on a first time of receipt of the received optical signal and a second time of receipt of the second received optical signal.

3. The system of claim 1 wherein the optical signal is a plurality of pulses and the distance detection circuit detects the plurality of distances signals in response to one of the plurality of pulses.

4. The system of claim 1 wherein the processor in operation switches from a first operating mode to a second operating mode based on the status signal.

5. The system of claim 1, further comprising:
a display, the distance detection circuit having a field of view that extends from the display.

6. The system of claim 1, further comprising:
a memory coupled to the processor and operable to generate and store the stored ear profile based on the plurality of distances.

7. The system of claim 1, further comprising:
a speaker fixed with respect to the distance detection circuit and coupled to the processor, the processor in operation drives the speaker to generate an audio signal based on the status signal.

8. A device, comprising:
an ear detection circuit including:
a signal transmitter that outputs a ranging signal;
a first signal receiver that receives a first reflected ranging signal;
a second signal receiver that receives a second reflected ranging signal; and
a timing circuit that determines a plurality of first distances in response to the first reflected ranging signal and the second reflected ranging; and
a processor that receives the plurality of first distances and outputs a control signal in response to the plurality of first distances corresponding to a plurality of second distances that represent a stored ear profile.

9. The device of claim 8 wherein the ranging signal is a pulse and the timing circuit outputs a plurality of third distance signals in response to each pulse.

10. The device of claim 8 wherein the processor is operable to switch from a first operating mode to a second operating mode based on the plurality of first distances corresponding to the plurality of second distances.

11. The device of claim 8 wherein the processor is operable to output an audio signal based on the plurality of first distances corresponding to the plurality of second distances.

12. The device of claim 8 wherein the control signal is a security bypass signal.

13. The device of claim 8 wherein the ear detection circuit outputs a second ranging signal, receives a third reflected ranging signal processor is configured to cease output of the audio signal based on the detection of the absence of the ear.

14. A method, comprising:
generating a ranging signal at a ranging sensor;
detecting a reflection of the ranging signal at the ranging sensor;
determining with a time delay circuit a propagation time based on the detecting of the reflection of the ranging signal;
calculating a distance based on the propagation time;
generating an ear model based on the calculating the distance;
comparing the ear model to a stored ear profile with a processor; and
generating a status signal representing the result of the comparing the ear model to the stored ear profile.

15. The method of claim 14 wherein the detecting the reflection of the ranging signal includes:
detecting a reference reflection of the ranging signal with a first signal receiver to generate a first time; and
detecting a return reflection of the ranging signal with a second signal receiver to generate a second time, the time delay circuit determining the propagation time by subtracting the first time from the second time.

16. The system of claim 14, further comprising:
detecting a second reflection of the ranging signal at the ranging sensor;
determining with the time delay circuit a second propagation time based on the detecting of the second reflection of the ranging signal;
calculating a second distance based on the second propagation time;
generating the ear model based on the calculating the second distance.

17. The system of claim 14, further comprising:
switching the processor from a first operating mode to a second operating mode based on the status signal, the second operating mode unlocking a user profile for the user associated with the stored ear profile.

18. The system of claim 14, further comprising:
unlocking a lock screen on a display of an electronic device based on the status signal, the ranging sensor having a field of view that extends from the display.

19. The system of claim 14, further comprising:
storing the ear model as a second stored ear profile.

20. The system of claim 14, further comprising:
playing a first audio signal over a speaker based on the status signal being in a first state; and
playing a second audio signal over the speaker based on the status signal being in a second state.
